(19) United States
(12) Patent Application Publication
(10) Pub. No.: US 2017/0263254 A1
(43) Pub. Date: Sep. 14, 2017

(54) MALWARE-PROOF PRIVACY INDICATOR

(71) Applicant: Intel IP Corporation, Santa Clara, CA (US)

(72) Inventors: PRASHANT DEWAN, Hillsboro, OR (US); UTTAM K. SENGUPTA, Portland, OR (US); SATISH KUMAR L. BHRUGUMALLA, Fremont, CA (US); MANDAR S. JOSHI, Santa Clara, CA (US)

(73) Assignee: lntel IP Corporation, Santa Clara, CA (US)

(21) Appl. No.: 15/066,434

(22) Filed: Mar. 10, 2016

(51) Int. Cl. G10L 15/28; G10L 15/24; G10L 15/22

(52) U.S. Cl. CPC G10L 15/28; G10L 15/22; G10L 15/24; G10L 2015/223; G10L 2015/226

(57) ABSTRACT

A voice command device (VCD) has privacy protection. The VCD comprises a processor, first and second input devices, at least one data line to couple the first and second input devices to the processor, a power supply, and a sensor power line to couple the first and second input devices to the power supply. The VCD also comprises a manually operated mechanical switch on the sensor power line, to divide the sensor power line into a first leg comprising the power supply and a second leg comprising the input devices. The VCD also comprises an active sensor indicator light on the second leg of the sensor power line. The indicator light is configured to indicate whether the input devices are operational, based on a power level of the second leg of the sensor power line. Other embodiments are described and claimed.

### TECHNICAL FIELD

This disclosure pertains in general to data processing systems that can sense audio, video, or other types of input, and in particular to malware-proof privacy indicators for such data processing systems.

### BACKGROUND

Many modern data processing systems feature microphones and provide for user interaction via voice commands. Such a data processing system may be referred to as a voice command device or “VCD.” A VCD may also feature other types of input devices or sensors, such as cameras, infrared detectors, etc. Some VCDs also use remote resources (such as information accessed via the Internet) to service voice commands. For instance, a smart phone with a microphone may continuously listen for a predetermined wake word, and after detecting the wake word, the smart phone may interpret the audio input that follows the wake word as a command. The phone may then use the Internet to process that command. For instance, if the wake word is “John,” the user may say “John, what is a patent?” In response, the smart phone may use the Internet to look up the requested definition from a website such as Wikipedia.com or Merriam-Webster.com. The smart phone may then use a speaker to audibly relay (or “read”) the definition to the user.

A VCD that can use remote resources (e.g., the Internet) to service voice commands may be referred to as a connected VCD (CVCD). A CVCD may be considered part of the so-called “Internet of Things” or “IoT.” According to the online encyclopedia known by the trademark WIKIPEDIA, the IoT is a “network of physical objects or ‘things’ embedded with electronics, software, sensors, and network connectivity, which enables these objects to collect and exchange data. The [IoT] allows objects to be sensed and controlled remotely across existing network infrastructure.”

One relatively recent example of a CVCD is the device currently being sold by Amazon.com, Inc. under the trademark AMAZON ECHO (hereinafter “Echo”). According to the WIKIPEDIA entry for “Amazon Echo,” the Echo is a “wireless speaker and voice command device” that features a seven-piece microphone array, and that is capable of performing a wide range of tasks in response to voice commands, such as playing music, making to-do lists, setting alarms, etc. The Echo uses the Internet to perform some or all of those operations.

For maximum convenience, users are expected always to leave the Echo on.

One issue with VCDs (and especially CVCDs) involves privacy. If a VCD is always monitoring input from sensors like microphones and cameras, the user may be concerned that the VCD will see or hear something that user considers to be private or sensitive. And the user might not trust the VCD with private information. For instance, the user might be worried that malware on the VCD will capture and share information that was intended to be private. Such concerns may be especially troubling for devices that are practically always on and sensing.

Some VCDs provide a function for disabling the microphone, but that function is implemented with software. For instance, software in a smart phone may present a mute option on a touch screen. Such an option may be referred to as a soft mute button. When a user selects a soft mute button, the software in the smart phone may update the display to indicate that the microphone has been muted. However, if the software is not trustworthy, the software might indicate that the microphone has been muted when it really has not been muted.

By contrast, a device that is much simpler than a VCD may not present the same kinds of risks. For instance, a conventional headset features two speakers, a mechanical volume control, a microphone, and a mechanical mute switch for disabling the microphone. Such a headset features no software. If a user puts the mute switch in the mute position, the user can be assured that the headset is not capturing audio.

According to WIKIPEDIA, by default, the Echo “continuously listens to all speech,” monitoring for the wake word to be spoken; however, the Echo's microphones can be manually disabled by pressing a mute button “to turn off the audio processing circuit.” The mute button may also be referred to as a microphone button.

The Echo also features a “light ring” to visually communicate the status of the Echo. In particular, the Amazon.com website lists the following seven light ring states and corresponding status descriptions:

1. Solid blue with spinning cyan lights: “Amazon Echo is starting up.”

2. All lights off: “Amazon Echo is active and waiting for your request.”

3. Solid blue with cyan pointing in direction of person speaking: “Amazon Echo is busy processing your request.”

4. Orange light spinning clockwise: “Amazon Echo is connecting to your Wi-Fi network.”

5. Solid red light: “You have turned off the microphones on your Amazon Echo. Press the Microphone button to turn on the microphones.”

6. White light: “You are adjusting the volume level on Amazon Echo.”

7. Continuous oscillating violet light: “An error occurred during Wi-Fi setup.”

(See “Amazon Device Support>Amazon Echo Help>Getting Started>About the Light Ring.”) Thus, if the light ring is shining a solid red light, the Echo is indicating that the microphones have been turned off. However, if the software controlling the Echo is not completely trustworthy (e.g., if the Echo has been affected by malware), the indication that the microphones have been turned off might not be trustworthy. In other words, the light ring may serve as a privacy indicator, but that privacy indicator may not be safe from malware.

As described in greater detail below, the present disclosure introduces malware-proof privacy indicators for VCDs and other data processing systems.

### BRIEF DESCRIPTION OF THE DRAWINGS

FIG. 1 is a block diagram of a first example embodiment of a data processing system with a malware-proof privacy indicator.

FIG. 2 is a block diagram of a second example embodiment of a data processing system with a malware-proof privacy indicator.

FIG. 3 is a block diagram of a third example embodiment of a data processing system with a malware-proof privacy indicator.

FIG. 4 is a block diagram of a fourth example embodiment of a data processing system with a malware-proof privacy indicator.

### DESCRIPTION OF EMBODIMENTS

The present disclosure presents multiple embodiments of data processing systems that may be used as VCDs. In addition, as described in greater detail below, the illustrated embodiments include malware-proof privacy indicators.

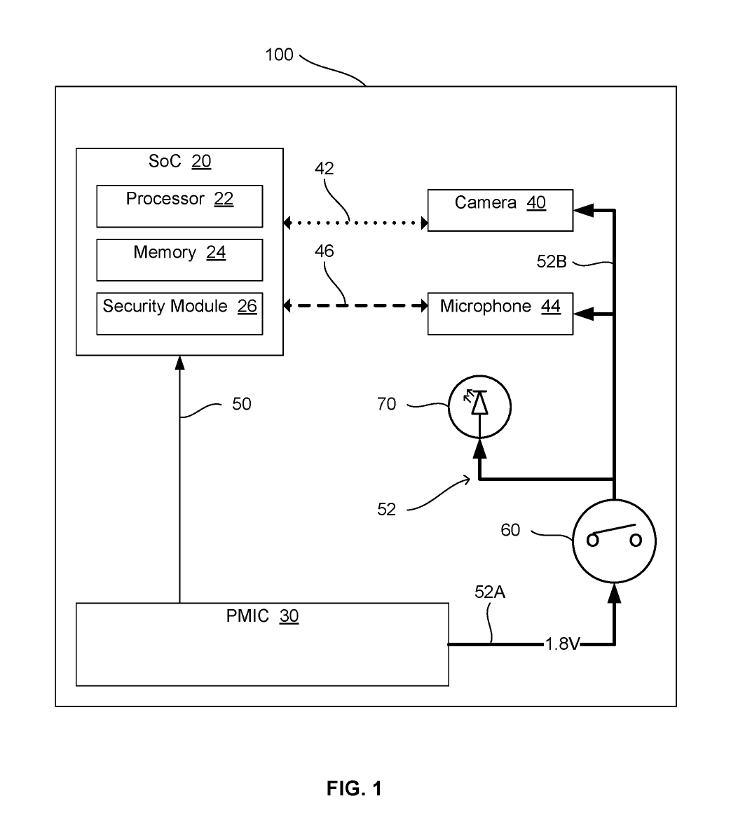

FIG. 1 is a block diagram of a first example embodiment of a data processing system 100 with a malware-proof privacy indicator 70. As shown, system 100 includes a processor 22 and memory 24. In the embodiment of FIG. 1, processor 22 and memory 44 are implemented as parts of a system on a chip (SoC) 20, along with a security module 26. Memory 24 may include software which executes on processor 22. The software may include, for example, an operating system (OS), a virtual machine monitor (VMM), and various applications.

Data processing system 100 also includes passive input devices such as a camera 40 and a microphone 44. For purposes of this disclosure, a passive input device is a component that can receive input without the user touching the system. Example passive input devices include microphones, cameras, and infrared detectors. Passive input devices may also be referred to as sensors. Data processing system 100 may also include one or more active input devices (e.g., a keyboard, a mouse, a touchscreen). For purposes of this disclosure, an active input device is a component that provides input to the system in response to physical manipulation by the user.

System 100 also includes a power management integrated circuit (PMIC) 30. PMIC 30 provides power to SoC 20 via one or more power rails with one or more different voltages. Those processor power rails are illustrated collectively in FIG. 1 as a power line 50. Also, PMIC 30 provides power to the sensors via a sensor power line 52. However, a mechanical switch 60 divides sensor power line 52 into a first sensor power line leg 52A and a second sensor power line leg 52B. For purposes of this disclosure, first sensor power line leg 52A may also be referred to as upstream leg 52A. Similarly, second sensor power line leg 52B may also be referred to as downstream leg 52B.

In the embodiment of FIG. 1, each of camera 40 and microphone 44 needs power to process input, each has only one power input terminal, and that terminal is connected to only one power line (i.e., sensor power line 52). Since microphone 44 needs power to process input, microphone 44 may be referred to as an “active microphone.” However, such a device may be referred to as “enabled” (or “operational”) when it is receiving the power it needs to process input, and as “disabled” (or “not operational”) when it is not receiving the power it needs to process input. Thus, when switch 60 is closed, camera 40 and microphone 44 get the power they need from downstream leg 52B, and they are thus enabled or operational. When switch 60 is open, they do not receive power from downstream leg 52B, and they are thus disabled or not operational. Also, in certain embodiments, as described below, a sensor may also require a clock signal to process input. Such a sensor may be referred to as “enabled” if it is receiving power, and it may be referred to as “in use” or “in operation” if it is also receiving a clock signal. Thus, for purposes of this disclosure, sensors may be referred to as “operational” or “enabled” if they are capable of being used, and they may be referred to as being “in use” or “in operation” if they are actually being used.

Data processing system also includes a light-emitting diode (LED) 70 that is connected to the other components in a way that causes LED 70 to operate as a malware-proof privacy indicator. In particular, LED 70 is connected to downstream leg 52B. Consequently, if switch 60 is closed, downstream leg 52B receives power from upstream leg 52A, which causes camera 40 and microphone 44 to be enabled, and also causes LED 70 to be on (i.e., to emit light). On the other hand, if switch 60 is open, then downstream leg 52B does not receive power, which disables camera 40 and microphone 44, and also causes LED 70 to be off (i.e., to not emit light). Thus, LED 70 operates as an indicator of the privacy state of system 100 by reliably indicating whether passive input devices 40 and 44 are enabled or disabled.

Furthermore, even if system 100 were to become infected with malware, the malware would not be able to switch sensors 40 and 44 back on after the user has opened switch 60. Moreover, malware would not be able to change the status of the privacy indicator to indicate that the sensors are off when they are really on, or vice versa. Thus, LED 70 constitutes a malware-proof privacy indicator. For instance, LED 70 could be trusted even if malware were to infect the OS or a VMM within system 100.

In particular, In the embodiment of FIG. 1, the user can trust that sensors 40 and 44 are disabled if LED 70 is off and that sensors 40 and 44 are enabled if LED 70 is on. FIG. 1 thus illustrates an embodiment with two privacy states (either the sensor or enabled or not) and two corresponding indicator states (either the LED is on or not). Other embodiments may provide for the indicator to be on when the sensors are off, and/or for more than two indicator states.

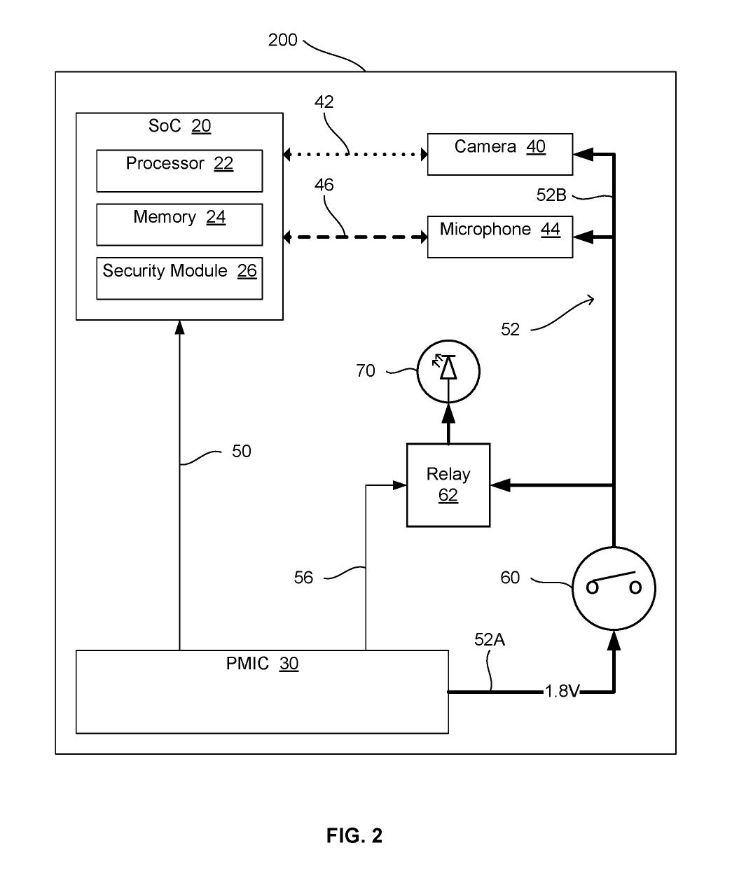

FIG. 2 is a block diagram of a second example embodiment of a data processing system 200. In the embodiment of FIG. 2, system 200 includes a malware-proof privacy indicator 70 that is on when the sensors are off. As illustrated, the embodiment of FIG. 2 may include the same components as the embodiment of FIG. 1; however, a relay 62 has been added to reverse how LED 70 operates. Relay 62 may receive power from PMIC 30 via a control power line 56. In addition, relay 62 monitors downstream leg 52B. If switch 60 is open (thereby disabling camera 40 and microphone 44), relay 62 causes LED 70 to be lit. If switch 60 is closed (thereby enabling camera 40 and microphone 44), relay 62 causes LED 70 to be off. FIG. 2 thus illustrates another embodiment with two privacy states and two corresponding indicator states.

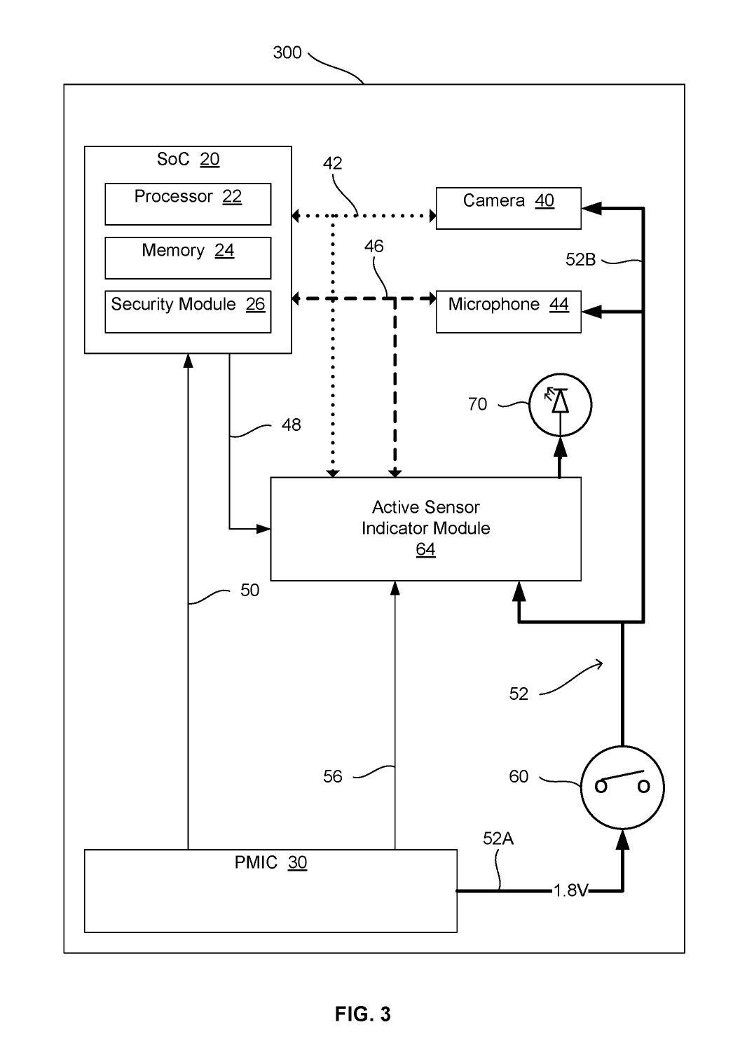

FIG. 3 is a block diagram of a third example embodiment of a data processing system 300 with a malware-proof privacy indicator 70 that provides more than two indicator states. The embodiment of FIG. 3 may include the same components as the embodiment of FIG. 2, except that relay 62 has been replaced with an active sensor indicator module (ASIM) 64 that monitors clock signals and causes LED 70 to indicate the current usage of the device, such that the status of LED 70 indicates when camera 40 and microphone 44 are being used, and not just enabled. In addition, FIG. 3 shows a data bus 42 that connects camera 40 to SoC 20 and a data bus 46 that connects microphone 44 to SoC 20. Those data buses may include clock lines to send clock signals from SoC 20 to sensors 40 and 44, and data lines to send data from sensors 40 and 44 to SoC 20. In one embodiment, data bus 42 is a mobile industry processor interface (MIPI) bus, and data bus 46 is an integrated interchip sound (I²S) bus, but other embodiment may use other types of buses.

ASIM 64 may include one or more relays like relay 62 of FIG. 2. In addition, ASIM 64 includes circuitry to monitor the clock lines on data buses 42 and 46, to determine whether SoC 20 is using camera 40 and microphone 44, rather than simply determining whether camera 40 and microphone 44 are enabled (i.e., receiving power). ASIM 64 also gets its own clock signal from a clock line 48 coming from SoC 20, and ASIM 64 gets power from PMIC 30 via control power line 56. In addition, ASIM 64 monitors downstream leg 52B.

To determine whether sensors like camera 40 and microphone 44 are being used, ASIM 64 may first determine whether switch 60 is set to the “on” or “enable” position, by testing for power on downstream leg 52B. If switch 60 is set to enable the sensors, for every clock tick on data bus 42 and on data bus 46, ASIM 64 records or flops the current state of that clock signal. Then, if the next clock signal state for any data bus matches the recorded state, ASIM 64 concludes that the clock on that bus is disabled and hence SoC 20 is not using the corresponding sensor. However, if consecutive clock states for a bus do not match, ASIM 64 concludes that the clock on that bus is enabled and the corresponding sensor is being used. If ASIM 64 concludes that SoC 20 is using at least one of the sensors, ASIM 64 responds by driving LED 70 to an indicator state that indicates that at least one of the sensors is being used, and that indicator state may differ from the indicator state for disabled sensors and the indicator state for enabled-but-not-used sensors.

Thus, ASIM 64 may use multiple states for LED 70 to reflect different states detected for the input devices. For instance, ASIM 64 may cause LED 70
(a) to be off when no power is detected on downstream leg 52B;
(b) to light solid green when the camera and microphone are enabled (i.e., receiving power) but neither is being used (based on detecting no clock signal on data bus 42 and data bus 46); and
(c) to blink green when camera 40, microphone 50, or both are being used (based on detecting an active clock signal on data bus 42 or on data bus 46).

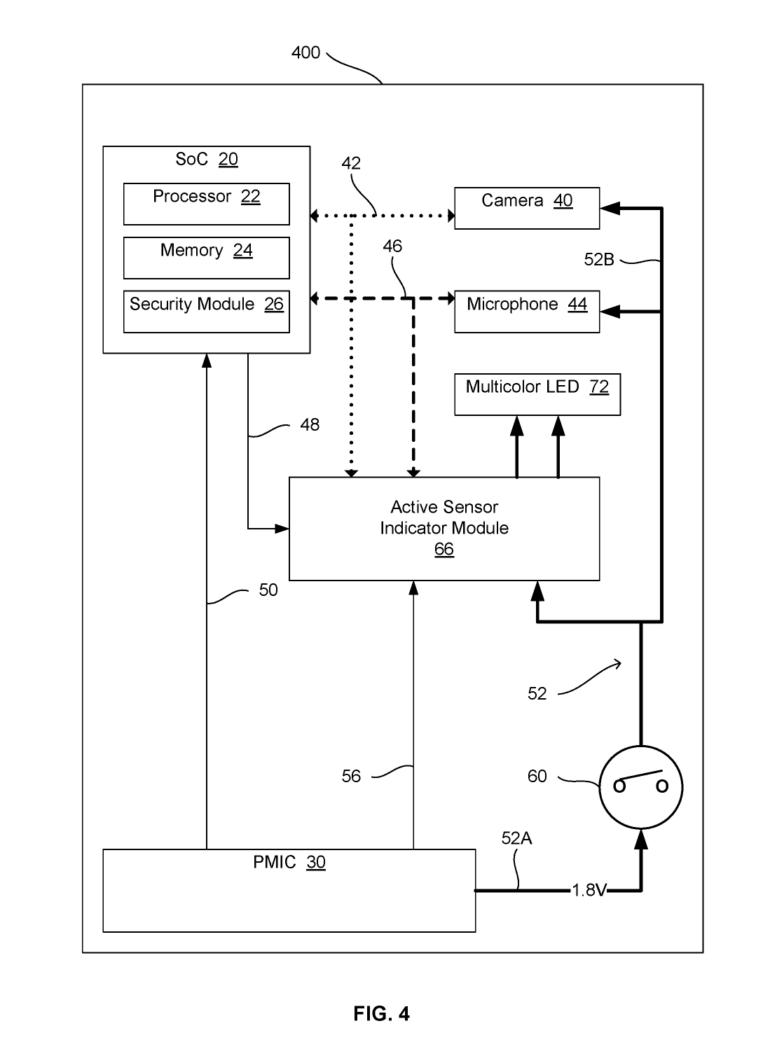

FIG. 4 is a block diagram of a fourth example embodiment of another data processing system 400 with a malware-proof privacy indicator that provides more than two indicator states. The embodiment of FIG. 4 may include the same components as the embodiment of FIG. 3, except a more complex ASIM 66 may be used, together with a multicolor LED (MLED) 72. The embodiment of FIG. 4 may operate basically like the embodiment of FIG. 3, but ASIM 66 may use different colors to reflect different states of the input devices. For instance, ASIM 66 may cause MLED 72
(d) to emit a (solid) red light when no power is detected on downstream leg 52B,
(e) to emit a (solid) green light when camera 40 and microphone 44 are enabled but neither is being used, and
(f) to blink green when any one or more of camera 40 and microphone 44 is being used.
   Data processing system 400 thus provides a multicolor malware-proof privacy indicator 72 that reflects multiple different privacy states.

For purposes of this disclosure, when no relevant sensors are enabled, the state of the system may be referred to as private. When at least one relevant sensor is enabled but no sensors are being used, the state of the system may be referred to as semi-private. And when at least one relevant sensor is enabled and being used, the state of the system may be referred to as non-private.

For purposes of illustration, the present disclosure describes one or more example embodiments. For instance, at least one embodiment described above includes two passive input devices (a microphone and a camera) and a mechanical switch for disabling (switching off) both of those passive input devices. But the present teachings are not limited to the particular embodiments described herein. Other embodiments contemplated, including embodiments with any suitable variations on the configurations described above.

For instance, alternative embodiments may include (a) a lesser or greater number of passive input devices and (b) a mechanical switch to control at least one of those passive input devices. For instance, the passive input devices in a system may include a microphone, a camera, and a global positioning system (GPS) sensor, and the mechanical switch may control the microphone and the camera but not the GPS sensor. For instance, the GPS sensor may use a different power line. In such an embodiment, the sensors on the leg that is controlled by the switch may be referred to as the relevant sensors.

In another alternative embodiment, the ASIM may only receive power the downstream leg of the sensor power line. Consequently, the ASIM may only check for clock signals when the switch is in the enable state, which enables the ASIM to receive power. Such an embodiment could use the following three states for the status indicator:
(a) off for all sensors disabled (no power),
(b) solid (or blinking) for enabled but not being used, and
(c) blinking (or solid) for enabled and at least one being used.
   Alternatively, blinking may indicate enabled but not being used, while solid indicates enabled and at least one being used.

Some embodiments may serve as nodes in the IoT.

In light of the principles and example embodiments described and illustrated herein, it will be recognized that the illustrated embodiments can be modified in arrangement and detail without departing from such principles. Also, even though expressions such as “an embodiment,” “one embodiment,” “another embodiment,” or the like are used herein, these phrases are meant to generally reference embodiment possibilities, and are not intended to limit the invention to particular embodiment configurations. As used herein, these phrases may reference the same embodiment or different embodiments, and those embodiments are combinable into other embodiments.

Any suitable operating environment and programming language (or combination of operating environments and programming languages) may be used to implement components described herein. As indicated above, the present teachings may be used to advantage in many different kinds of data processing systems. Example data processing systems include, without limitation, SoCs, MCUs, wearable devices, handheld devices, smartphones, telephones, entertainment devices such as audio devices, video devices, audio/video devices (e.g., televisions and set top boxes), vehicular processing systems, personal digital assistants (PDAs), tablet computers, laptop computers, portable computers, personal computers (PCs), workstations, servers, client-server systems, distributed computing systems, supercomputers, high-performance computing systems, computing clusters, mainframe computers, mini-computers, and other devices for processing or transmitting information. Accordingly, unless explicitly specified otherwise or required by the context, references to any particular type of data processing system (e.g., an SoC) should be understood as encompassing other types of data processing systems, as well. Also, unless expressly specified otherwise, components that are described as being coupled to each other, in communication with each other, responsive to each other, or the like need not be in continuous communication with each other and need not be directly coupled to each other. Likewise, when one component is described as receiving data from or sending data to another component, that data may be sent or received through one or more intermediate components, unless expressly specified otherwise. In addition, some components of the data processing system may be implemented as adapter cards with interfaces (e.g., a connector) for communicating with a bus. Alternatively, devices or components may be implemented as embedded controllers, using components such as programmable or non-programmable logic devices or arrays, application-specific integrated circuits (ASICs), embedded computers, smart cards, and the like. For purposes of this disclosure, the term “bus” includes pathways that may be shared by more than two devices, as well as point-to-point pathways. Also, for purpose of this disclosure, a processor may also be referred to as a processing unit, a processing element, a central processing unit (CPU), etc.

This disclosure may refer to instructions, functions, procedures, data structures, application programs, microcode, configuration settings, and other kinds of data. As described above, when the data is accessed by a machine or device, the machine or device may respond by performing tasks, defining abstract data types or low-level hardware contexts, and/or performing other operations. For instance, data storage, random access memory (RAM), and/or flash memory may include various sets of instructions which, when executed, perform various operations. Such sets of instructions may be referred to in general as software. In addition, the term “program” may be used in general to cover a broad range of software constructs, including applications, routines, modules, drivers, subprograms, processes, and other types of software components. Also, applications and/or other data that are described above as residing on a particular device in one example embodiment may, in other embodiments, reside on one or more other devices. And computing operations that are described above as being performed on one particular device in one example embodiment may, in other embodiments, be executed by one or more other devices.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein. For example, alternative embodiments include machine accessible media encoding instructions or control logic for performing the operations of the invention. Such embodiments may also be referred to as program products. Such machine accessible media may include, without limitation, tangible storage media such as magnetic disks, optical disks, RAM, read only memory (ROM), etc., as well as processors, controllers, and other components that include RAM, ROM, and/or other storage facilities. For purposes of this disclosure, the term “ROM” may be used in general to refer to non-volatile memory devices such as erasable programmable ROM (EPROM), electrically erasable programmable ROM (EEPROM), flash ROM, flash memory, etc. In some embodiments, some or all of the control logic for implementing the described operations may be implemented in hardware logic (e.g., as part of an integrated circuit chip, a programmable gate array (PGA), an ASIC, etc.). In at least one embodiment, the instructions for all components may be stored in one non-transitory machine accessible medium. In at least one other embodiment, two or more non-transitory machine accessible media may be used for storing the instructions for the components. For instance, instructions for one component may be stored in one medium, and instructions another component may be stored in another medium. Alternatively, a portion of the instructions for one component may be stored in one medium, and the rest of the instructions for that component (as well instructions for other components), may be stored in one or more other media. Instructions may also be used in a distributed environment, and may be stored locally and/or remotely for access by single or multi-processor machines.

Also, although one or more example processes have been described with regard to particular operations performed in a particular sequence, numerous modifications could be applied to those processes to derive numerous alternative embodiments of the present invention. For example, alternative embodiments may include processes that use fewer than all of the disclosed operations, process that use additional operations, and processes in which the individual operations disclosed herein are combined, subdivided, rearranged, or otherwise altered.

In view of the wide variety of useful permutations that may be readily derived from the example embodiments described herein, this detailed description is intended to be illustrative only, and should not be taken as limiting the scope of coverage.

The following examples pertain to further embodiments.

Example A1 is a VCD with privacy protection. The VCD comprises (a) a processor; (b) first and second input devices; (c) at least one data line to couple the first and second input devices to the processor; (d) a power supply; (e) a sensor power line to couple the first and second input devices to the power supply; and (f) a manually operated mechanical switch on the sensor power line to divide the sensor power line into a first leg comprising the power supply and a second leg comprising the first and second input devices. The VCD also comprises an active sensor indicator light on the second leg of the sensor power line with the first and second input devices. The active sensor indicator light is configured to indicate whether any of the first and second input devices are operational, based on a power level of the second leg of the sensor power line.

Example A2 is a VCD according to Example A1, wherein the mechanical switch can be manually switched between a closed position and an open position. The closed position (a) allows power to reach the first and second input devices and (b) causes the active sensor indicator light to emit light. The open position (c) prevents power from reaching the first and second input devices and (d) prevents the active sensor indicator light from emitting light.

Example A3 is a VCD according to Example A1, wherein the active sensor indicator light is permanently configured to emit light whenever the second leg of the sensor power line carries enough power to enable at least one of the first and second input devices to process input. Example A3 may also include the features of Example A2.

Example A4 is a VCD according to Example A1, further comprising a relay on the second leg of the sensor power line, interposed between the mechanical switch and the active sensor indicator light. The relay is permanently configured (a) to automatically send power to the active sensor indicator light in response to detecting no power on the second leg of the sensor power line and (b) to automatically prevent power from reaching the active sensor indicator light in response to detecting power on the second leg of the sensor power line. Example A4 may also include the features of any one or more of Examples A2 and A3.

Example A5 is a VCD according to Example A4, further comprising a control power line to couple the relay to the power supply. Also, the mechanical switch can be manually switched between (a) a closed position which allows power to reach the first and second input devices and (b) an open position which prevents power from reaching the first and second input devices. Also, the relay causes the active sensor indicator light to emit light when the mechanical switch is in the open position, and the relay prevents the active sensor indicator light from emitting light when the mechanical switch is in the open position.

Example A6 is a VCD according to Example A1, wherein each of the first and second input devices requires power to process input. Also, each of the first and second input devices has only one connection to power, and that connection is to the second leg of the sensor power line. Example A6 may also include the features of any one or more of Examples A2 through A5.

Example A7 is a VCD according to Example A1, wherein the active sensor indicator light comprises a light emitting diode (LED). Example A7 may also include the features of any one or more of Examples A2 through A6.

Example A8 is a VCD according to Example A1, wherein the power supply comprises a power management integrated circuit (PMIC). Example A8 may also include the features of any one or more of Examples A2 through A7.

Example A9 is a VCD according to Example A1, wherein the VCD further comprises at least one processor power line to couple the processor to the power supply. Example A9 may also include the features of any one or more of Examples A2 through A8.

Example B1 is a VCD with privacy protection. The VCD comprises (a) a processor; (b) an input device that requires power to process input; (c) a data bus to couple the input device to the processor; (d) a power supply; (e) a sensor power line to couple the input device to the power supply; and (f) a manually operated mechanical switch on the sensor power line to divide the sensor power line into a first leg comprising the power supply and a second leg comprising the input device. The VCD also comprises an active sensor indicator light on the second leg of the sensor power line. The active sensor indicator light is configured to indicate whether the input device is operational. The VCD also comprises an active sensor indicator module (ASIM) coupled to the data bus, to the second leg of the sensor power line, and to the active sensor indicator light. The ASIM is permanently configured to (a) detect whether the sensor power line carries enough power to enable the input device; (b) detect whether the data bus has an active clock signal; (c) put the active sensor indicator light in a first state in response to detecting that (i) the sensor power line carries enough power to enable the input device, while (ii) the data bus has an active clock signal; and (d) put the active sensor indicator light in a second state in response to detecting that (iii) the sensor power line carries enough power to enable the input device, while (iv) the data bus does not have an active clock signal.

Example B2 is a VCD according to Example B1, wherein the ASIM is also permanently configured to put the active sensor indicator light in a third state in response to detecting that the sensor power line does not carry enough power to enable the input device.

Example B3 is a VCD according to Example B2, wherein the active sensor indicator light comprises a multicolor LED. Also, the ASIM is configured to cause the multicolor LED to emit one color of light for one state of the input device and a different color of light for a different state of the input device.

Example B4 is a VCD according to Example B3, wherein (a) the ASIM is configured to cause the multicolor LED to blink when the input device is in the first state, (b) the ASIM is configured to cause the multicolor LED to steadily emit one color of light when the input device is in the second state, and (c) the ASIM is configured to cause the multicolor LED to steadily emit a different color of light when the input device is in the third state.

Example B5 is a VCD according to Example B1, wherein the data bus comprises a data line and a clock line. Example B5 may also include the features of any one or more of Examples B2 through B4.

Example B6 is a VCD according to Example B1, wherein the data bus comprises at least one bus from the group consisting of (a) a mobile industry processor interface (MIPI) bus and (b) an integrated interchip sound (I²S) bus. Example B6 may also include the features of any one or more of Examples B2 through B5.

Example B7 is a VCD according to Example B1, wherein the input device has only one connection to power, and that connection is to the second leg of the sensor power line. Example B7 may also include the features of any one or more of Examples B2 through B6.

Example B8 is a VCD according to Example B1, wherein the VCD further comprises a processor power line to couple the processor to the power supply. Example B8 may also include the features of any one or more of Examples B2 through B7.

Example C1 is a method to provide privacy protection for a VCD having a processor, a power supply, first and second input devices, a sensor power line to couple the first and second input devices to the power supply, at least one data line to couple the first and second input devices to the processor, a manually operated mechanical switch on the sensor power line to divide the sensor power line into a first leg comprising the power supply and a second leg comprising the first and second input devices, a relay coupled to the second leg of the sensor power line, and an active sensor indicator light responsive to the relay. The method comprises detecting, at the relay, whether the second leg of the sensor power line is carrying enough power to enable at least one of the input devices. In response to detecting that the second leg of the sensor power line does not carry enough power to enable at least one of the input devices, the relay automatically causes the active sensor indicator light to emit light. In response to detecting that the second leg of the sensor power line is carrying enough power to enable at least one of the input devices, the relay automatically prevents the active sensor indicator light from emitting light.

Example C2 is a method according to Example C1, wherein the VCD further comprises a control power line to couple the relay to the power supply. The mechanical switch can be manually switched between (a) a closed position which allows power to reach the first and second input devices and (b) an open position which prevents power from reaching the first and second input devices. The relay causes the active sensor indicator light to emit light when the mechanical switch is in the open position, and the relay prevents the active sensor indicator light from emitting light when the mechanical switch is in the open position.

Example C3 is a method according to Example C2, wherein each of the first and second input devices requires power to process input. Also, each of the first and second input devices has only one connection to power, and that connection is to the second leg of the sensor power line.

Example D1 is a method to provide privacy protection for a VCD having a processor, a power supply, an input device, a sensor power line to connect the input device to the power supply, a data bus to connect the input device to the power supply, a mechanical switch on the sensor power line to divide the sensor power line into a first leg comprising the power supply and a second leg comprising the input device, an active sensor indicator module (ASIM), and an active sensor indicator light responsive to the ASIM. The method comprises automatically detecting, at the ASIM, whether the second leg of the sensor power line carries enough power to enable the input device. The ASIM also automatically detects whether the data bus has an active clock signal. The ASIM automatically puts the active sensor indicator light in a first state in response to detecting that (i) the sensor power line carries enough power to enable the input device, while (ii) the data bus has an active clock signal. The ASIM automatically puts the active sensor indicator light in a second state in response to detecting that (iii) the sensor power line carries enough power to enable the input device, while (iv) the data bus does not have an active clock signal.

Example D2 is a method according to Example D1, further comprising automatically putting the active sensor indicator light in a third state in response to detecting that the sensor power line does not carry enough power to enable the input device.

Example D3 is a method according to Example D2, wherein the active sensor indicator light comprises a multicolor LED, and the method comprises automatically causing the multicolor LED to emit one color of light for one state of the input device and a different color of light for a different state of the input device.

Example D4 is a method according to Example D3, wherein the method comprises (a) automatically causing the multicolor LED to blink when the input device is in the first state, (b) automatically causing the multicolor LED to steadily emit one color of light when the input device is in the second state, and (c) automatically causing the multicolor LED to steadily emit a different color of light when the input device is in the third state.

Example D5 is a method according to Example D1, wherein the input device has only one connection to power, and that connection is to the second leg of the sensor power line. Example D5 may also include the features of any one or more of Examples D2 through D4.

Example E is a VCD with privacy protection. The VCD comprises means for performing the method of any one of Examples D1 through D5.

What is claimed is:

1. A voice command device with privacy protection, the voice command device comprising:
a processor;
first and second input devices;
at least one data line to couple the first and second input devices to the processor;
a power supply;
a sensor power line to couple the first and second input devices to the power supply;
a manually operated mechanical switch on the sensor power line to divide the sensor power line into a first leg comprising the power supply and a second leg comprising the first and second input devices; and
an active sensor indicator light on the second leg of the sensor power line with the first and second input devices, wherein the active sensor indicator light is configured to indicate whether any of the first and second input devices are operational, based on a power level of the second leg of the sensor power line.

2. A voice command device according to claim 1, wherein:
the mechanical switch can be manually switched between a closed position and an open position;
the closed position (a) allows power to reach the first and second input devices and (b) causes the active sensor indicator light to emit light; and
the open position (c) prevents power from reaching the first and second input devices and (d) prevents the active sensor indicator light from emitting light.

3. A voice command device according to claim 1, wherein the active sensor indicator light is permanently configured to emit light whenever the second leg of the sensor power line carries enough power to enable at least one of the first and second input devices to process input.

4. A voice command device according to claim 1, further comprising:
a relay on the second leg of the sensor power line, interposed between the mechanical switch and the active sensor indicator light, wherein the relay is permanently configured (a) to automatically send power to the active sensor indicator light in response to detecting no power on the second leg of the sensor power line and (b) to automatically prevent power from reaching the active sensor indicator light in response to detecting power on the second leg of the sensor power line.

5. A voice command device according to claim 4, further comprising:
a control power line to couple the relay to the power supply; and
wherein:
the mechanical switch can be manually switched between (a) a closed position which allows power to reach the first and second input devices and (b) an open position which prevents power from reaching the first and second input devices;
the relay causes the active sensor indicator light to emit light when the mechanical switch is in the open position; and
the relay prevents the active sensor indicator light from emitting light when the mechanical switch is in the open position.

6. A voice command device according to claim 1, wherein:
each of the first and second input devices requires power to process input; and
each of the first and second input devices has only one connection to power, and that connection is to the second leg of the sensor power line.

7. A voice command device according to claim 1, wherein the active sensor indicator light comprises a light emitting diode (LED).

8. A voice command device according to claim 1, wherein the power supply comprises a power management integrated circuit (PMIC).

9. A voice command device according to claim 1, further comprising at least one processor power line to couple the processor to the power supply.

10. A voice command device with privacy protection, the voice command device comprising:
a processor;
an input device that requires power to process input;
a data bus to couple the input device to the processor;
a power supply;
a sensor power line to couple the input device to the power supply;
a manually operated mechanical switch on the sensor power line to divide the sensor power line into a first leg comprising the power supply and a second leg comprising the input device;
an active sensor indicator light on the second leg of the sensor power line, wherein the active sensor indicator light is configured to indicate whether the input device is operational; and
an active sensor indicator module (ASIM) coupled to the data bus, to the second leg of the sensor power line, and to the active sensor indicator light, wherein the ASIM is permanently configured to:
(a) detect whether the sensor power line carries enough power to enable the input device;
(b) detect whether the data bus has an active clock signal;
(c) put the active sensor indicator light in a first state in response to detecting that (i) the sensor power line carries enough power to enable the input device, while (ii) the data bus has an active clock signal; and
(d) put the active sensor indicator light in a second state in response to detecting that (iii) the sensor power line carries enough power to enable the input device, while (iv) the data bus does not have an active clock signal.

11. A voice command device according to claim 10, wherein the ASIM is also permanently configured to put the active sensor indicator light in a third state in response to detecting that the sensor power line does not carry enough power to enable the input device.

12. A voice command device according to claim 11, wherein:
the active sensor indicator light comprises a multicolor LED; and
the ASIM is configured to cause the multicolor LED to emit one color of light for one state of the input device and a different color of light for a different state of the input device.

13. A voice command device according to claim 12, wherein:
the ASIM is configured to cause the multicolor LED to blink when the input device is in the first state;
the ASIM is configured to cause the multicolor LED to steadily emit one color of light when the input device is in the second state; and
the ASIM is configured to cause the multicolor LED to steadily emit a different color of light when the input device is in the third state.

14. A voice command device according to claim 10, wherein the data bus comprises a data line and a clock line.

15. A voice command device according to claim 10, wherein the data bus comprises at least one bus from the group consisting of:
a mobile industry processor interface (MIPI) bus; and
an integrated interchip sound (I²S) bus.

16. A voice command device according to claim 10, wherein the input device has only one connection to power, and that connection is to the second leg of the sensor power line.

17. A voice command device according to claim 10, further comprising:
a processor power line to couple the processor to the power supply.

18. A method to provide privacy protection for a voice command device, the method comprising:
in a voice command device (VCD) comprising a processor, a power supply, first and second input devices, a sensor power line to couple the first and second input devices to the power supply, at least one data line to couple the first and second input devices to the processor, a manually operated mechanical switch on the sensor power line to divide the sensor power line into a first leg comprising the power supply and a second leg comprising the first and second input devices, a relay coupled to the second leg of the sensor power line, and an active sensor indicator light responsive to the relay, detecting, at the relay, whether the second leg of the sensor power line is carrying enough power to enable at least one of the input devices;
in response to detecting that the second leg of the sensor power line does not carry enough power to enable at least one of the input devices, automatically causing the active sensor indicator light to emit light; and
in response to detecting that the second leg of the sensor power line is carrying enough power to enable at least one of the input devices, automatically preventing the active sensor indicator light from emitting light.

19. A method according to claim 18, wherein:
the VCD further comprises a control power line to couple the relay to the power supply;
the mechanical switch can be manually switched between (a) a closed position which allows power to reach the first and second input devices and (b) an open position which prevents power from reaching the first and second input devices;
the relay causes the active sensor indicator light to emit light when the mechanical switch is in the open position; and
the relay prevents the active sensor indicator light from emitting light when the mechanical switch is in the open position.

20. A method according to claim 19, wherein:
each of the first and second input devices requires power to process input; and
each of the first and second input devices has only one connection to power, and that connection is to the second leg of the sensor power line.

21. A method to provide privacy protection for a voice command device, the method comprising:
in a voice command device (VCD) comprising a processor, a power supply, an input device, a sensor power line to connect the input device to the power supply, a data bus to connect the input device to the power supply, a mechanical switch on the sensor power line to divide the sensor power line into a first leg comprising the power supply and a second leg comprising the input device, an active sensor indicator module (ASIM), and an active sensor indicator light responsive to the ASIM, automatically detecting, at the ASIM, whether the second leg of the sensor power line carries enough power to enable the input device;
automatically detecting, at the ASIM, whether the data bus has an active clock signal;
automatically putting the active sensor indicator light in a first state in response to detecting that (i) the sensor power line carries enough power to enable the input device, while (ii) the data bus has an active clock signal; and
automatically putting the active sensor indicator light in a second state in response to detecting that (iii) the sensor power line carries enough power to enable the input device, while (iv) the data bus does not have an active clock signal.

22. A method according to claim 21, further comprising:
automatically putting the active sensor indicator light in a third state in response to detecting that the sensor power line does not carry enough power to enable the input device.

23. A method according to claim 22, wherein:
the active sensor indicator light comprises a multicolor LED; and
the method comprises automatically causing the multicolor LED to emit one color of light for one state of the input device and a different color of light for a different state of the input device.

24. A method according to claim 23, wherein the method comprises:
automatically causing the multicolor LED to blink when the input device is in the first state;
automatically causing the multicolor LED to steadily emit one color of light when the input device is in the second state; and
automatically causing the multicolor LED to steadily emit a different color of light when the input device is in the third state.

25. A method according to claim 21, wherein the input device has only one connection to power, and that connection is to the second leg of the sensor power line.
